(19) United States
(12) Patent Application Publication
(10) Pub. No.: US 2002/0195376 A1
(43) Pub. Date: Dec. 26, 2002

(54) Method for the separation of a mixture of differing particulate types

(76) Inventor: Harold Edward Siess, Gaithersburg, MD (US)

Correspondence Address: Harold E. Siess, 8629 Welbeck Way, Gaithersburg, MD, 20879, US

(21) Appl. No.: 09/950,000

(22) Filed: Sep. 12, 2001

Related U.S. Application Data
(60) Provisional application No. 60/231,564, filed on Sep. 11, 2000.

(51) Int. Cl. B03B 1/00

(52) U.S. Cl. 209/3

(57) ABSTRACT

The present invention provides for a method for the separation of a mixture of differing particulate types comprising the steps of: a) selecting a coating material; b) coating said coating material onto at least two different particulate types in said mixture of differing particulate types for forming a mixture of coated particulate types; c) measuring the fracture strength of at least one coated particulate types in said mixture of coated particulate types under at least one applied stress subjected at a controlled rate; d) applying at least one substantially uniform stress on at least one coated particulate type in said mixture of coated particulate types at a controlled rate for fracturing at least one coated particulate type in said mixture of coated to a greater degree than for at least one other particulate type in said mixture of coated particulate types for forming a mixture of differentially fractured types; e) separating said mixture of differentially fractured types for separating said mixture of differing particulate types.

### BACKGROUND OF THE INVENTION

This invention relates to a process for the recovery of mineral particles from gangue by differential fracture techniques. More particularly, this invention relates to a process for the separation and recovery of mineral particles from gangue utilizing differential fracture techniques operating in conjunction with specified separation and recovery means.

Industrial nations are constantly increasing their metal consumption and the known supply of metal, and particularly copper, lead and zinc, is shrinking. In a few years, the metal industry may not be able to supply the world needs. Similarly, the supply of previous metals and minerals is shrinking. There are, however, still large quantities of minerals and metals in very low grade ore that have been heretofore untouched because of the difficulty in recovering the valuable minerals and metals from the other solid materials, referred to as gangue, which are of little value.

In the low grade ore, the desired minerals many times appear only as just a few specks mixed with other minerals and solids, and a great amount of material must be handled to recover the small amount of desired mineral or metal. Any process for recovery of the desired minerals from low grade ore should involve as few handling steps as possible. In addition, there has been difficulty in developing processes that can detect or select the small amount of mineral from the large amount of solids of little value generally termed gangue. This operation known as ore dressing or concentration generally involves comminution or fragmentation of the ore to small size to permit easy separation of the different kinds of solids, followed by one or more sorting operations designed to distinguish and separate the valuable mineral particles from the rest. In the past, the sorting has generally been accomplished by techniques, such as, for example, those based on gravity, magnetism, chemical attraction or reaction.

The gravity separation processes depend upon the different rates of fall through water and are patterned after the simple panning technique where the particles are swirled with water in a shallow conical dish with the effect that the dense particles stratify in the bottom while the lighter mineral, being more buoyant, remain partly suspended and can be decanted with water from time to time. The modern successors to the panning technique use more complicated steps and equipment, but the process is still limited by difficulty of obtaining particles of the right size, interference with walls and bottom of the containing vessels, and the like.

The magnetic separation process can be used for separating only a few minerals. The most obvious case is that of the ferromagnetic magnetite and minerals that can be chemically altered to become magnetic. Such separators work efficiently only if the material is presented in rather a thin layer only a few particles deep. Consequently, the design of a high capacity plant for use with fine material at reasonable cost is scarcely practicable.

Froth flotation is probably the more desirable of the sorting processes as it operates through the sensitive surface properties of the individual minerals. It is generally applicable to very fine concentrates and can distinguish, not only ore mineral from gangue, but one mineral from another. Briefly, conditions are arranged so that when a mixture is agitated and air bubbles are blown through it, certain minerals attach themselves to the bubbles and are floated out of a froth which is skimmed off and discharged of its mineral burden. In many cases, the surface properties of the ore and gangue minerals vary within too narrow a range to be useful for effective separation, and, as a result, certain organic compounds called collectors are added to bring about more selective adsorbtion. The main type of collectors are organic acids, their salts, organic bases and oils, such as kerosene, creosotes, diesel or fuel oils. To be effective, these processes generally require strict control over particle size, of pH and the addition of many additives, such as conditioners, wetting agents, frothing agents, which add greatly to the cost, particularly when treating large quantities of ore. In addition, the technique requires that the minerals be ground to very fine particles before an effective separation can be accomplished.

### OBJECTS OF THE INVENTION

It is an object of the present invention to provide a fracture process for extracting metals and minerals from mixtures containing them.

It is a further object of the invention to provide a process for sorting or extracting valuable metals and minerals from gangue by a fracture technique, which can be effectively operated on large quantities of ore with few operational steps, is operative with particles of great variety of size, is dependent upon very few process variables and can be made effective for the separation of a great variety of different metals and mineral ores.

### SUMMARY OF THE INVENTION

The present invention provides for a method for the separation of a mixture of differing particulate types. The differing particulate types can be in the form of crushed ores or minerals, dirty coal or a mixture of spent and fresh catalytic materials. The method comprises the steps of first selecting a coating material for coating at least two different particulate types in the mixture of differing particulate types for forming a mixture of coated particulate types. In one form of the invention, the coating material is selected for forming a mixture of coated particulate types having different fracture strengths. The fracture strength of at least one coated particulate type is then measured under at least one applied stress which is applied at a controlled rate for finding the fracture threshold for at least one coated particulate type in the mixture of coated particulate types. The mixture is then differentially fractured for forming a mixture of fractured types. In one form of the present invention, the differential fracturing is accomplished by applying at least one substantially uniform stress which is at least as great as the lowest fracture threshold to the mixture of coated particulate types at a uniform rate for fracturing at least one coated particulate types to a greater degree than for at least one other particulate type for forming a mixture of differentially fractured types. The mixture of differentially fractured types are then separated for separating the mixture of differing particulate types.

In one form of the invention, the stress is applied for forming a mixture of differentially fractured types having differing bulk properties such as size, shape, density, heat conductivities, and ability to be magnetically manipulated. The differing bulk properties of the fractured mixture is then used to separate the differing particulate types by such methods as screening, gravitational, magnetic separation, aerodynamic sizing and differential bouncing.

In another form of the present invention, the stress is applied for forming a mixture of differentially fractured types having differing surface properties such as refractive index, luminosity, fluorescence, optical absorbency, catalytic nature, electrical conductivities, ability to become electrostatically charged, and hydrophobic nature. The differing surface properties of the fractured mixture is then used to separate the differing particulate types by “hand picking” separation techniques, electrostatic separation and floatation.

In another form of the present invention, heat is applied to the mixture of coated particulate types from at least one heating source for forming a mixture of differentially strained coated particulate types having different fracture strengths. The fracture strength of at least one coated particulate types in the mixture of differentially strained types is then measured for finding the fracture threshold for at least one coated particulate types. At least one stress, which is at least as great as the fracture threshold for at least one coated particulate type is uniformly applied to the differentially strained coated particulate types for fracturing at least one coated particulate type in said mixture of differentially strained coated particulate types to a greater extent than for at least one other coated particulate types for forming a mixture of differentially fractured types.

In yet another form of the invention for forming a mixture of differentially fractured types, the mixture of coated particulate types is exposed to a fluid which can be either a gas or a liquid while the fracturing stress is applied for changing the fracture strength of at least one coated particulate type to a geater extent than for at least one other coated particulate type for forming a mixture of differentially fractured types.

In another form of the invention, a stress is applied to a mixture of coated particulate types for fracturing at least one coated particulate type in said mixture for forming a mixture of differentially fractured types that are also differentially electrostatically charged. The differentially electrostatically charged types are then electrostatically separated.

The present invention also provides for an additional method for the separation of a mixture of differing particulate types comprising the steps of first forming a mixture of differentially coated particulate types having differing fracture strengths. The differentially coated particulate types are than selectively fractured for forming a mixture of differentially fractured types which are then separated for separating the differing particulate types.

The present invention provides for three methods for forming differentially coated particulate types. In the first, the method comprises the steps of first selectively coating with a first coating material at least one particulate type in a mixture of particulate types. The mixture is then coated with a second coating material for forming a mixture of differentially double coated particulate types having differing fracture strengths. The first coating material can comprise a solid or a fluid which can be in the form of individual particles or in the form of a continuous layer.

In the second form of the invention, the method for forming differentially coated particulate types comprises the steps of selecting a coating material for selectively reacting with at least one particulate type in a mixture of particulate types to a greater extent or in a different way than for at least one other particulate type. The coating material is then applied under conditions for selectively reacting the coating material for forming a mixture of differentially coated particulate types having differing fracture strengths.

In the third form of the invention for differentially coating particulate types includes the steps of: (a) coating a mixture of differing particulate types with a coating material for forming a mixture of coated particulate types and then (b) holding said mixture of coated particulate types at a substantially uniform temperature for forming a fluid layer at the interface of at least one coated particulate type to a greater extent than for at least one other coated particulate type for forming said mixture of differentially coated particulate types.

The present invention also provides for a third method for the separation of a mixture of differing particulate types. The third method comprises the steps of: (a) selecting a coating material; (b) coating said coating material onto at least two different particulate types in said mixture of differing particulate types for forming a mixture of coated particulate types at least one of said coated particulate types having at least one boundary layer; (c) applying a stress to said mixture of coated particulate types for separating matter at a boundary layer for forming a mixture of differentially bounded particulate types; and (d) separating the differentially bounded particulate types for separating said mixture of differing particulate types.

The present invention also provides for several methods for the separation of a mixture of differing particles. In one form of the invention, the differing particle types can be in the form of differing particulate types such as crushed minerals or ores, dirty coal or a mixture of spent and fresh catalytic materials. In another form of the invention, the differing particle types can be in the form of differing biological cells such as but not limited to bacteria or human cells.

In one form of the invention, the method for the separation of particles comprises the steps of first selecting a coating material for coating at least two different particles in the mixture of differing particles for forming a mixture of coated particles. An energizing field is then applied to the mixture of coated particles for forming a mixture of particles having different strains or different fracture strengths. The mixture is then differentially fractured for forming a mixture of fractured types. In one form of the present invention, the differential fracturing is accomplished by applying at least one substantially uniform stress to the energized mixture for forming a mixture of differentially fractured types. The mixture of differentially fractured types are then separated for separating the mixture of differing particles.

The above method can also comprise the steps of measuring the fracture strength of at least one of the coated particles in the energized mixture for forming the fracture threshold for at least one coated particle type in the mixture of coated particles. A stress is then applied which is at least as great as the lowest fracture threshold for the mixture of coated particles for forming the mixture of differentially fractured types.

In one form of the invention, the stress is applied for forming a mixture of differentially fractured types having differing bulk properties such as size, shape, density, heat conductivities, and ability to be magnetically manipulated. The differing bulk properties of the fractured mixture is then used to separate the differing particulate types by such methods as screening, gravitational, magnetic separation, aerodynamic sizing and differential bouncing.

In another form of the present invention, the stress is applied for forming a mixture of differentially fractured types having differing surface properties such as refractive index, luminosity, fluorescence, optical absorbency, catalytic nature, electrical conductivities, ability to become electrostatically charged, and hydrophobic nature. The differing surface properties of the fractured mixture is then used to separate the differing particulate types by “hand picking” separation techniques, electrostatic separation and floatation.

In another form of the invention, a stress is applied to a mixture of energized coated particles for fracturing at least one coated particle type in said mixture for forming a mixture of differentially fractured types that are also differentially electrostatically charged. The differentially electrostatically charged types are then electrostatically separated.

The present invention also provides for an additional method for the separation of a mixture of differing particles comprising the steps of first forming a mixture of differentially coated particles. The mixture of differentially coated particles is then energized by an energizing field for forming a mixture of differentially strained particles. The mixture of differentially strained particles are than subject to at least one applied stress for forming a mixture of differentially fractured types which are then separated for separating the differing particle types.

### BRIEF DESCRIPTION OF THE DRAWINGS

FIG. 1 is a schematic of a method for the separation of particles by using differences in the adherence properties of the particles to coating matter.

FIG. 2 shows a schematic of a method for altering the adhesion of a mixture of differing particle types that are in the form of ores, minerals, or coal to a coating material.

FIG. 3 shows a method and apparatus for forming differentially coated particles and their separation.

FIG. 4 shows a method and apparatus for forming differentially coated particles and separating them using a thermal expander/separator.

FIG. 5 shows a method and apparatus for forming differentially coated particles and separating them using a heat stress/separator.

FIG. 6 shows a method and apparatus for forming differentially coated particles and separating using an electromagnetic separator.

FIG. 7 shows a method and apparatus for forming differentially coated particles and separating using a magnetic heater/separator.

FIG. 8 shows a method and apparatus for forming differentially coated particles and separating using an electric field heater/separator.

FIG. 9 shows a method and apparatus for coating particles by condensation.

FIG. 10 shows a method and apparatus for coating a mixture of particles with differing thicknesses.

FIG. 11 shows a method and apparatus for forming differentially coated particles and separating them using an electromagnetic heater/separator.

FIG. 12 shows a method and apparatus for forming differentially coated particles and separating them using an microwave heater/separator.

FIG. 13 shows a method and apparatus for forming differentially coated particles and separating them using an electromagnetic conduction heater/separator.

### DETAILED DESCRIPTION OF THE INVENTION

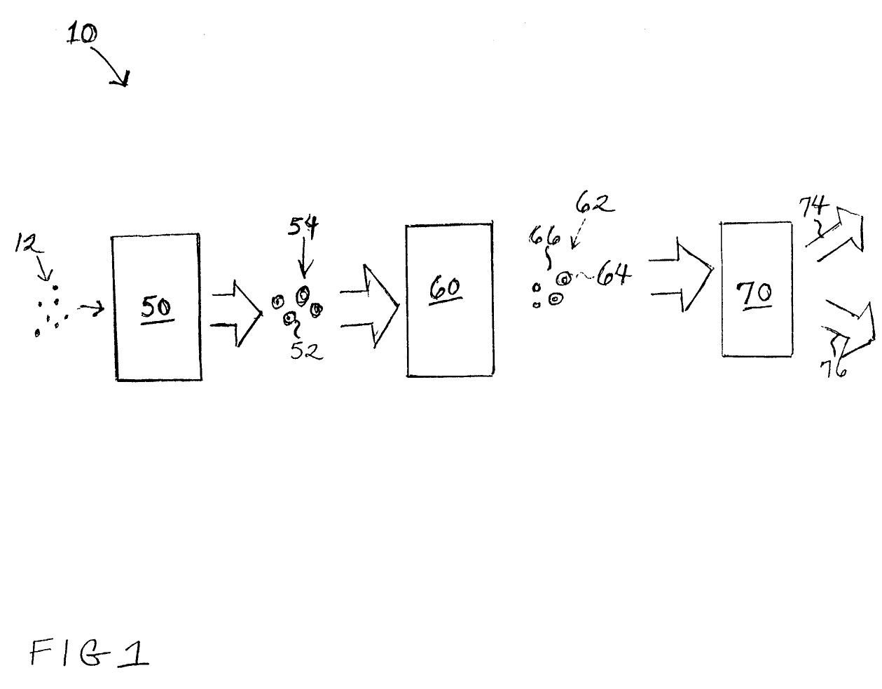

Now referring to FIG. 1, there is shown a schematic of a method for the separation of particles by using differences in the adherence properties of the particles to coating matter. The method is a selective shedding process for the separation of particles and is generally indicated by the numeral 10.

The selective shedding process 10 operates as follows. A mixture, generally indicated by the numeral 12, to be separated is selected. Mixture 12 can be selected to be in the form of crushed ores, minerals, coal and the like, or mixture 12 can be selected to be a mixture of fresh [good] and spent [bad] catalytic materials or mixture 12 can be selected to be a plurality of differing biological cell types. Mixture 12 is comprised of a plurality of particle types generally indicated by the numeral 14 having either (1) naturally occurring differences in their adhesion strength (adherence) to a material coating or (2) are imparted with such differences in accordance with the teachings of the present invention.

Mixture 12 is then passed through a coating device 50 for coating at least two particle types contained in mixture 12 with at least one coating material 52 for forming a mixture of coated particle types generally indicated by the numeral 54 having differing pressure and/or abrasion sensitivities. In particular, mixture 12 is passed through device 50 for coating mixture 12 for forming a mixture of coated particle types 54 comprised of one more coated particle types 56 [not shown] having a low pressure and/or abrasion sensitivity and one or more particle types 58 [not shown] having a higher pressure or abrasion sensitivity. Coating device 50 can be any type well known in the art for coating particles, particulates, granules, or fine matter.

The mixture of coated particles is then imparted with energy one or more times by at least one energy imparting device 60. Device 60 can be of a type for imparting a substantially equal amount of energy to each coated particle type for removing more matter from particles 58 then from particles 56 for forming a mixture of differentially coated particles generally indicated by the numeral 62 comprised of one or more more coated particle types 64 and one or more less coated particle types 66. Device 60 can be any known device(s) for applying energy to matter or can be one in accordance with the teachings of the present invention.

Mixture 62 is then passed through one or more separators 70 for separating particles 64 from particles 66 for separating the differing particle into at least two separate streams generally indicated by the arrows 74 and 76 for separating particle types 14 from each other. Separator 70 can be any known means for separating particles. In the preferred form of the invention, separator 70 is of a type for separating mixture 62 in a more efficient manner than for separating mixture 12. Separator 70 can be for example and not limiting the present invention to, an electrostatic separator, a floatation separator, a filtering device, inertial separator, other known physical separator or a separator in accordance with the teachings of the present invention.

In the preferred form of the invention, the stress sensitivity of at least one particle type in the mixture of coated particles is determined by a tester 80 for determining the stress sensitivity of at least one particle type in the mixture for determining the amount of applied energy by the energy imparting device.

The present invention also provides for a method for the determination of the kind and degree of coating removal by use of an acoustic emission detector for detecting the level and kind of acoustic emission occurring during the impartation or transmission of energy process. In the preferred form of the invention, the detector is in the form of a microphone located in or near the region of imparted energy for detecting acoustic waves and producing a signal. The signal is then sent to an acoustic analyzer of a type well known in the art for analyzing the signal and for directing an appropriate response in the decoating process, such as but not limited to, the amount and rate of energy applied by the stressing device.

The present invention also provides for a method for the determination of the kind and degree of coating removal by use of a temperature detector for detecting the level temperature of the coated particles during the applied stress process. In the preferred form of the invention, the detector is in the form of a thermocouple located in or near the region of imparted energy for detecting the temperature and producing a signal. The signal is then sent to an analyzer (a computer connected with the acoustic detector) of a type well known in the art for analyzing the signal and for directing an appropriate response in the decoating process such as but not limited to the amount and rate of energy applied by the stressing device.

The present invention also provides for another method for the determination of the kind and degree of coating removal in the form of a fine particle detector for measuring the amount and kinds of fines generated during the decoating process. In one form of the invention, the fine particle detector is in the form of a filter for collecting an measuring the amount of fines created. In another form of the invention, the fine particle detector is in the form of a blower for blowing a fluid through a pile processed coated particles for determining the degree of fines generated by measuring the amount of fluid passed through the batch of processed coated particles in a given time.

Major New Invention

The present invention also provides for yet another method for the determination of the kind and degree of coating removal by measuring the vibrational energy imparted to the particles by the imparting device.

In another form of the invention, the mixture of coated particles is sized by a sizer before being passed through the stressing device for forming a mixture of substantially uniformly sized coated particles and thereby increase the selectivity of the coating removal process.

The present invention provides for three general methods for selectively altering the pressure and/or abrasion sensitivities of one or more coated particle types in the mixture of coated particles for increasing the efficiency of the separation process. These three general methods are (1) selecting mixture 12 having differing particle types having differing adhesion strengths or adherences to the coating material, (2) pretreating the mixture of particles before the coating step for increasing the differnces in the adhesion strengths or adherences to the coating for one or more particle types to a greater extent than for at least one other particle type, or (3) coating the mixture of particles in such a way to bring about increased differences in adhesion strengths or adherences of one or more particle types to the coating material than for at least one other particle type.

I. Selecting the Mixture of Particles for Having Differing Particle Types Having Differing Adhesion Strengths or Adherences to the Coating Material by:

1. Selecting a mixture 12 for containing particles 14 that differ in one or more of the following properties: composition, crystalline structure or particle morphologies for creating a plurality of substantially uniformly coated particle types 22 having differing pressure or abrasion sensitivities.

2. Selecting a mixture 12 for containing particles 14 that differ in wetting ability to one or more coating material(s) for creating a plurality of coated particle types 22 having differing pressure or abrasion sensitivities.

3. Selecting a mixture 12 for containing particles that differ in their ability to form solid matter at the coating-particle interface at a set temperature for creating a plurality of coated particle types having differing pressure or abrasion sensitivities due to the presence of a fluid at the interface for at least one particle type while one other particle type has a solid layer at that temperature. For example around −13 C. ice forms at the interface around some particle types and for others is forms a liquid layer between the particle and the ice.

4. Selecting a mixture 12 for containing particles that differ in their surface energies for creating a plurality of coated particle types having differing pressure or abrasion sensitivities. 5. Selecting a mixture 12 for containing particles that differ in their ability to form compounds with coating material for creating a plurality of coated particle types having differing pressure or abrasion sensitivities. In another form of the invention, mixture 12 is selected for containing particles 14 at least one of which is capable of forming compounds with coating material for creating a mixture of coated particles having differing adherences.

6. Selecting a mixture 12 for containing particles at least one of which is capable of interacting with a fluid while being imparted with energy for removing more coating material from those surfaces.

7. Selecting a mixture 12 for containing particles that have differing pressure or abrasion sensitivities at different rates of imparting energy for forming a mixture of differentially coated particles to be separated.

II. Coating the Mixture of Particles in Such a Way to Bring About Increased Differences in their Adhesion Strengths or Adherences to the Coating Material for One or More Particle Types to a Greater Extent than for at Least One Other Particle Type by

1. A) Selecting a mixture 12 for containing particles that differ in their ability to cure coating material (b)two or more particle types in mixture 12 are then coated and then after a selected time interval one or more particle types are decoated. This form of the invention is particularly useful when applied to coating forming electrostatic bonds with the particles.

2. Selecting a coating material for forming a coating comprising one or more discrete layers with little or no compound formation. This may be accomplished by selecting a coating material that is chemically inert to the mixture of particles. In particular, a chemically inert coating material can be selected for forming a discrete layer on the particles that is held thereon by one or more of the following forces

1) electrostatic attraction

2) polar bonds

3) ionic bonds or

4) Van der Waals forces.

This method of separation by selective removal of a discrete layer or layers of coating material is particularly useful in the separation of particles having differences in one or more of the following properties

A) particle composition,

B) crystalline structure or

C) particle morphologies

such that the differing particle types form different types or degrees of binding forces for forming a mixture of coated particle types having differing adhesive strengths.

Another advantage of forming a discrete layer of coating material is that the material can be recovered at the end of the separation process and recycled.

3. Selecting a coating material for selectively interdiffusing with at least one type of particle in the mixture of particles for forming an interdiffused layer at the coating-particle interface. The mixture of particles is then coated for forming an interdiffused layer on selected particle types for creating a mixture of coated particles having differing pressure and/or abrasion sensitivities.

4. Selecting a coating material for coating the mixture of particles by evaporation for forming a mixture of coated particle types having differing pressure or abrasion sensitivities. In particular, selecting a coating material for coating a mixture of particles having differing porosities for forming a mixture of coated particles having differing pressure or abrasion sensitivities.

III. Pretreating the Mixture of Particles Before the Coating Step for Increasing the Differences in the Adhesion Strengths or Adherences to the Coating

The present invention provides for several method and apparatuses for imparting energy to the coated particles for forming a mixture of differentially coated particles. These methods and apparatuses can be used separately or in combination for effectually achieving differentially coated particles. In one form of the invention, the energy is imparted to the coated particles by an energy imparting device in the form of a mechanical impactor for imparting energy by impaction. In this form of the invention, the coated mixture of particles are physcially moved about in such a manner by the mechanical impactor that the coated particles come into contact with each other, or other objects for imparting energy thereto. The contacting or impacting can be of a singe type or can be comprised of a number of impacts. In the preferred form of the invention, the number of impacts and the amount of energy imparted to each of the coated particle types is substantially the same for removing a greater amount of coating material from particle types having a low pressure or abrasion sensitivity. The impacts can be in the form of, but are not limited to, one or more of the following: striking, shearing and or frictional forces.

In another form of the invention, the energy is imparted to the mixture of coated particles by an energy imparting device in the form of an expansion device for imparting energy in the form of pressure at the particle-coating interface. In this form of the invention the mixture of particles 12 is coated with one or more coating materials in a fluid under pressure; the mixture of coated particles is then brought to a region of lower pressure by such an expansion device as an expansion nozzle for imparting energy in the form of built up pressure at the particle-coating interface. In the preferred of the invention, the coating material is comprised of an inner layer of more volatile material than that of an out coating material. The inner coating material can be in the form of a fluid. This form of the invention can be easily coupled with an additional energy imparting device in the form of a mechanical for both imparting energy in the form of built up pressure and in the form of mechanical energy.

In still another form of the invention, the energy is imparted to the mixture of coated particles by an energy imparting device in the form of a heater. The mixture of coated particles can be either (1) heated uniformly (or nearly uniformly) or (2) heated nonuniformly.

In another form of the invention, the energy is imparted to the mixture of coated particles by an energy imparting device in the form of an electromagnetic radiator for selectively heating one or more particle types to a greater extent than for at least one other particle type.

In the preferred form of the invention, the differences in the adherences or binding energies of the differing particles to the coating is great enough such that they can be differentially decoated in kind or degree by the use of a controlled amount of imparted energy. In addition to these energy requirements, it is preferred that the overall energy used in the decoating process be low for reducing the cost of processing. The present invention therefore provides for several methods for forming coated particles having differing adherences while having at least one particle type having a coating that is easy to remove.

In one form of the invention, the coating material is selected for forming a frangible or cleavable coating for easily splitting of matter when imparted with energy. In this form of the invention, the coating material can be selected from but not limited to the group comprised of ice, gas hydrates, an inorganic salt or a mixture of such salts, such as but not limited to nitrates, carbonates, bicarbonates, phosphates, silicates and chlorides, especially alkali metal salts and alkaline earth metal salt, and minerals which liberate molecularly bound water or water of crystallization upon heating.

In another form of the invention, the coating material is comprised of organic matter which can be in the form of polymers. In either case, the coating material can be applied in the form of a gas, liquid, semiliquid or solid. For liquids and semiliquids, after expose to the liquids or semiliquids material is allowed to set. The set may result form evaporation, solidification, deemulification, crosslink formation or other method for setting liquids well known in the art of coating.

The coating may be carried out by any conventional coating process, e.g. by contacting the particles with a solution under vaporizing conditions in a rotating inclined disk, a rotary drum, or in a fluidized bed.

The choice of apparatus in which to carry out the coating process is not critical. Thus it may be for example, a rotating inclined disk, or a rotary drum. Other similar equipment may also be used. A particularly preferred apparatus is a fluidised bed, operated conventionally so that the particles are fluidised by an upward-flowing inert gas such as air or nitrogen and are contacted with a solution, the solvent of which evaporates off depositing a coating on the particles. The solution may be injected directly into the bed, srayed onto the bed or dispersed in the upward-flowing inert gas. The process may be operated batchwise, or continuously by using a compartmented bed. The exit of the coated particles may be obtained by a simple overflow device or by elutriation via an outlet located at any desired level in the bed.

Whichever apparatus employed it is preferable that the particles should be contacted with solution at a temperature sufficiently high to result in rapid evaporation of solvent from the solutions. Clearly, the preferred temperature will depend upon the solvent used and for water should be of the order of 60° C. or more.

In the preferred form of the invention, the fines generated by the coating removal process are separatly withdrawn from the decoater (energy impacting device).

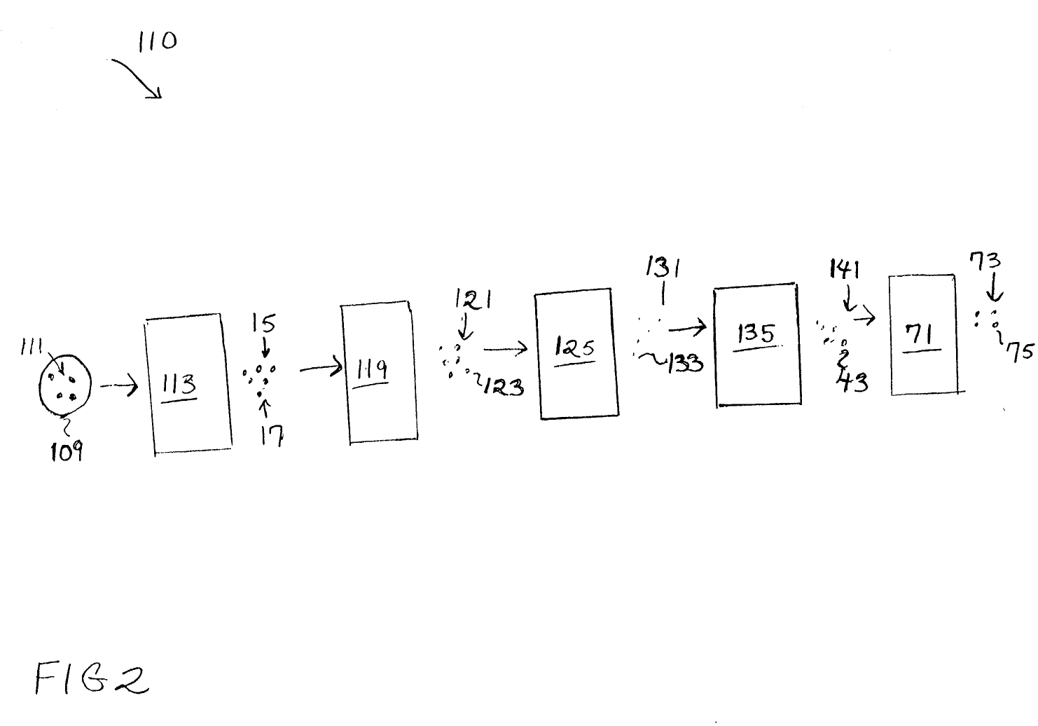

Now referring to FIG. 2, there is shown a schematic of a method for altering the adhesion of a mixture of differing particle types that are in the form of ores, minerals, or coal to a coating material. The method is an ore, mineral or coal pretreatment process generally indicated by the numeral 110 for altering the degree of adherences of at least one particle type to a coating material.

The ore, mineral, or coal pretreatment process operates as follow. A mixture of particles generally indicated by the numeral 111 in a bulk 109 are passed through a reducing device 113 for liberating particles 11 for forming a mixture generally indicated by the numeral 115 of free particles generally indicated by the numeral 117. Reducing device 113 can be any known type of reducer for liberating particles form ores, minerals or coal.

The mixture 115 of free particles 117 is then passed through a sizer 119 for forming a mixture generally indicated by the numeral 121 of substantially uniformly sized particles 123. Sizer 119 can be any known sizer, such as but not limited to a screening separator of a type well known in the art.

Mixture 121 is then passed through a washer 125 for removing contaminates therefrom for forming a mixture 131 comprised of substantially uniformly sized, and substantially clean particles 133.

Mixture 131 is then passed through a dyer 135 for dying mixture 131 of particles 133 for forming a mixture generally indicated by the numeral 41 comprised of substantially uniformly sized substantially cleaned and substantially dried particles 143 having a well defined adhesion strength for each particular particle type. After this pretreatment the mixture of particles is then ready for separation in accordance with the teachings of the present invention.

In another form of the invention, mixture 141 is then passed through and additional pretreater 171 for forming a mixture generally indicated by the numeral 173 of particles 175 having a higher degree of differences in their pressure or abrasion sensitivities. Pretreater 171 can be an oxidzer for oxidizing particles 143, a reducer for reducing particles 143, a water exposer for forming a layer of water on at least one particle type or be of a type in accordance with the teachings of the present invention.

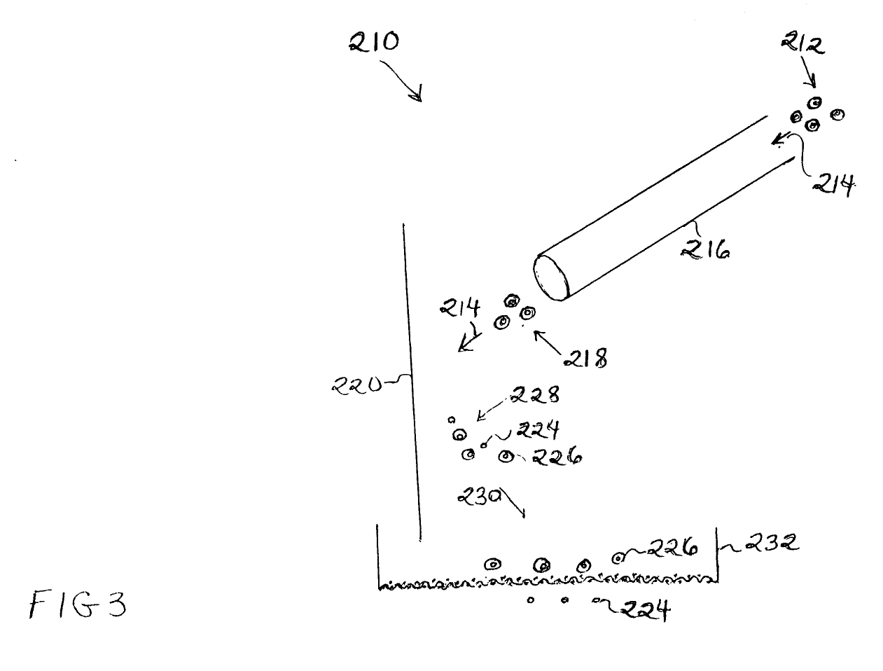

Now referring to FIG. 3 there is shown a method and apparatus for forming differentially coated particles and their separation. The apparatus is a decoating particle separator generally indicated by the numeral 210.

The decoating particle separator 210 operates as follows. A mixture generally indicated by the numeral 212 of two or more coated particle types is accelerated by a flow of air in a direction generally indicated by the numeral 214 through an expansion nozzle or tube 216. The accelerated mixture of coated particles generally indicated by the numeral 218 is exposed to an energy imparting device in the form of a contact surface 220 for imparting energy to the mixture of coated for removing matter from at least one particle type 224 having a greater pressure or abrasion sensitivity to a greater extent than for at least one other particle type 226 having a lower pressure or abrasion sensitivity for forming a mixture of differentially coated particles generally indicated by the numeral 228. Mixture 228 is then allowed to fall in the direction indicated by the arrow 230 and into a screen shaker 232 for separating particle types 224 and 226 from each other for separating the differing types of particles.

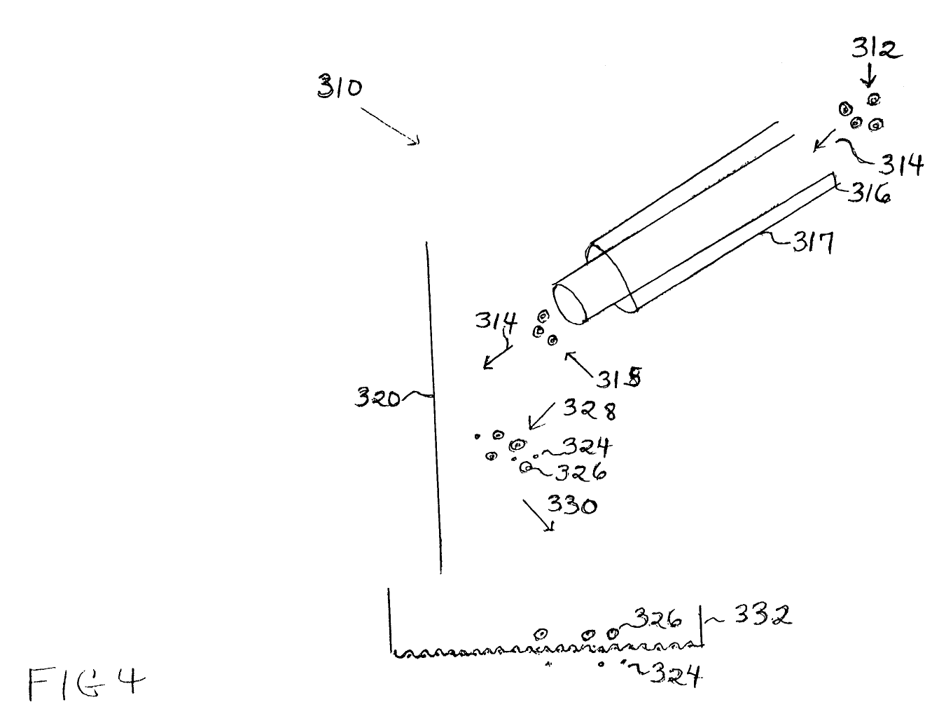

Now referring to FIG. 4, there is shown another method and apparatus for forming differentially coated particles and their separation. The apparatus is a thermal expander/separator generally indicated by the numeral 310.

The thermal expander/separator 310 operates as follows. A mixture generally indicated by the numeral 310 of two or more coated particle types is passed into an expansion nozzle or tube 316. Tube 316 in in intamate contact with a heat exchanger for either heating or cooling the mixture of coated particles 312 for imparting or removing energy therefrom for thermally stressing to at least one particle type to a greater extent than for at least one other particle type for forming a mixture generally indicated by the numeral 315 of differentially thermally stressed particle types. The thermal stress may be in the form of a thermal expansion or contraction of the particles contained in the coated particles 312. Mixture 315 is is then exposed to an additional energy imparting device 320 for imparting energy to the mixture of coated particles for removing matter form at least one coated particle type 324 to a greater extent than at least one other particle type 326 for forming a mixture of differentially coated particles generally indicated by the numeral 328. Energy imparting device 320 is of a type for apply a force to the mixture of coated particles. In the preferred form of the invention, energy imparting device 320 is of a type for applying a impact force, or a pulling force or a vibrating force or combination thereof. Mixture 528 falls in the direction indicated by the arrow 330 and into a screen shakeer 332 for separating particle types 324 and 326 from each other for separating the differing types of particles.

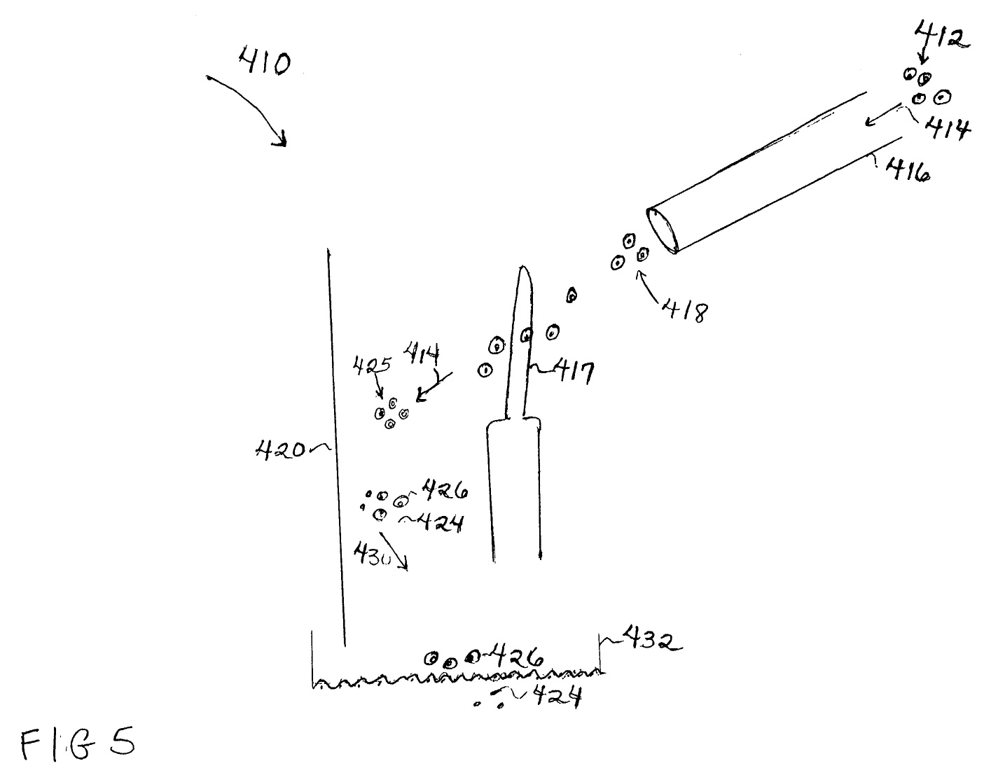

Now referring to FIG. 5, there is shown another form of the invention for forming differentially coated particles and their separation. The apparatus is a heat stress/separator generally indicated by the numeral 410.

The heat stress/separator 410 operates as follows. A mixture generally indicated by the numeral 412 of two or more coated particle types is accelerated by a flow of air generally indicated by the arrow 214 through a tube 416. The accelerated mixture of coated particles generally indicated by the numeral 218 is passed through a energy imparting device in the form of a flame for thermally stressing at least one particle type to a greater extent than for at least one other particle type in the mixture for forming a mixture generally indicated by the numeral 425 of differentially thermally stressed coated particles. The thermal stress can be due but is not limited to differences in the thermal conductivities of the differing particle type to be separated. Mixture 425 is then exposed to an additional energy imparting device in the form of a contact surface 420 for imparting energy to mixture 425 of differentially thermally stressed coated particles for removing matter form at least one coated particle type 424 to a greater extent than for at least one other particle type 426 for forming a mixture of differentially coated particles generally indicated by the numeral 428. Mixture 428 falls in the direction indicated by the arrow 430 and into a screen shaker 432 for separating particle types 424 and 426 from each other for separating the differing types of particles.

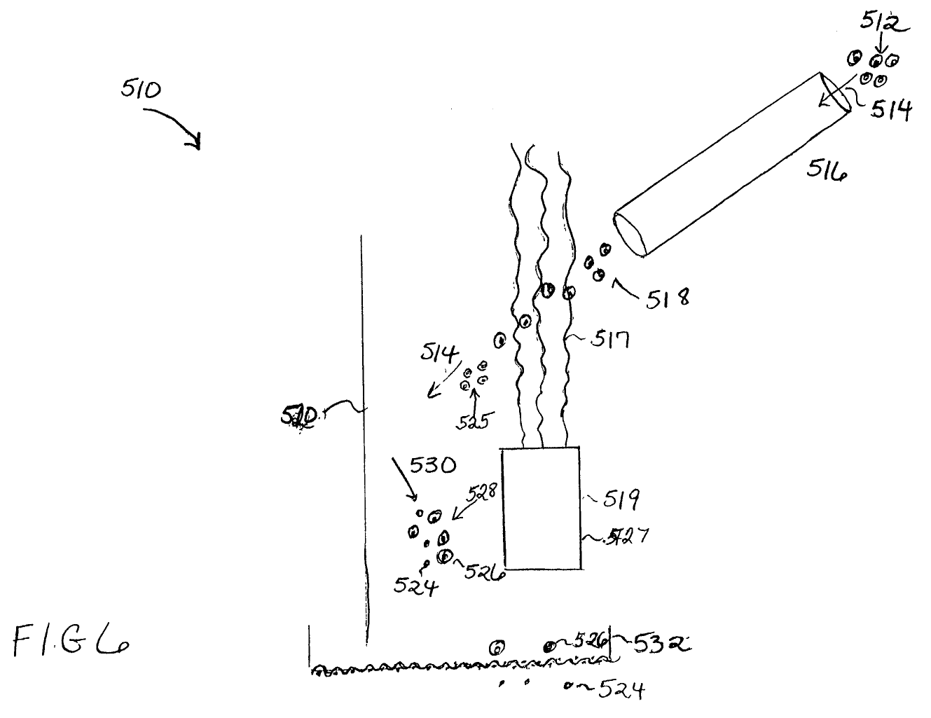

Now referring to FIG. 6 there is shown a yet another method and apparatus for forming differentially coated particles and their separation. The apparatus is a electromagnetic separator generally indicated by the numeral 510.

The electromagnetic separator 510 operates as follows. A mixture generally indicated by the numeral 512 of two or more coated particle types is accelerated by a flow of air generally indicated by the arrow 514 through a tube 516. The accelerated mixture of coated particles generally indicated by the numeral 518 is passed through a energy imparting device in the form of an electromagnetic wave 417 generated by an electromagnetic wave generator 427 for thermally stressing at least one particle type to a greater extent than for at least one other particle type in the mixture for forming a mixture generally indicated by the numeral 525 of differentially thermally stressed coated particles. Electromagnetic wave generator 527 can be a microwave source, an rf heater, a light source for emitting light in the ir, near ir, visible or uv spectrum such as a laser. In the preferred form of the invention for minerals the light generator 527 is a tungsten filament with a polished aluminum reflector for forming imparting energy to the interface with visible light. One or more filters can be used to filter the light from the tungsten filament for imparting visible light in a narrow spectrum region. The thermal stress generated in one or more particles can be due but is not limited to difference in the absorption characteristics of the differing particle types to be separated. Mixture 525 is then exposed to an additional energy imparting device in the form of a contact surface 520 for imparting energy to mixture 525 of differentially thermally stressed coated particles for removing matter form at least one coated particle type 524 to a greater extent than for at least one other particle type 526 for forming a mixture of differentially coated particles generally indicated by the numeral 528. Mixture 528 falls in the direction indicated by the arrow 530 and into a screen shaker 532 for separating particle types 524 and 526 from each other for separating the differing types of particles.

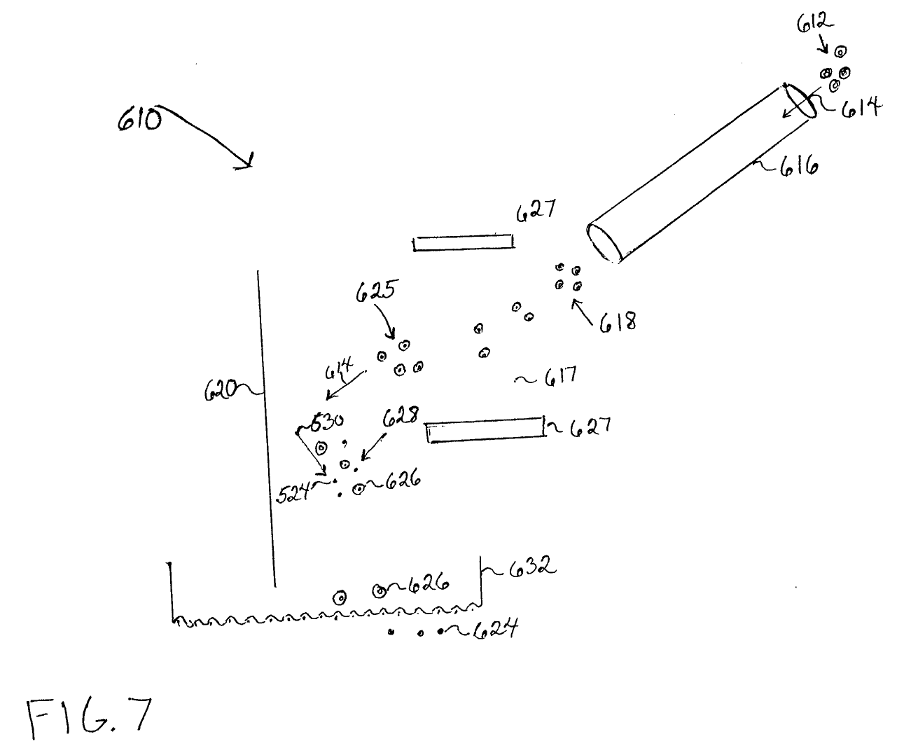

Now referring to FIG. 7 there is shown a still yet another method and apparatus for forming differentially coated particles and their separation. The apparatus is a magnetic heater/separator generally indicated by the numeral 610.

The magnetic heater/separator 610 operates as follows. A mixture generally indicated by the numeral 612 of two or more coated particle types is accelerated by a flow of air generally indicated by the arrow 614 through a tube 616. Mixture 612 contains one or more particle types that are capable of being heated by to a greater degree by an high frequency magnetic field than for at least one other particle in the mixture of coated particles. The accelerated mixture of coated particles generally indicated by the numeral 618 is passed through a energy imparting device in the form of an high frequency magnetic field 517 generated by an magnetic generator 627, of a type well known in the art, for thermally stressing at least one particle type to a greater extent than for at least one other particle type in the mixture for forming a mixture generally indicated by the numeral 625 of differentially thermally stressed coated particles. In the preferred form of the invention, high frequency magnetic field 617 is between 50 Hz to 100 Ghz for differentially heating differing particle types due to differences in hysteresis losses or Joule heating. Mixture 625 is then exposed to an additional energy imparting device in the form of a contact surface 620 for imparting energy to mixture 625 of differentially thermally stressed coated particles for removing matter from at least one coated particle type 624 to a greater extent than for at least one other particle type 626 for forming a mixture of differentially coated particles generally indicated by the numeral 628. Mixture 628 falls in the direction indicated by the arrow 630 and into a screen shaker 632 for separating particle types 624 and 626 from each other for separating the differing types of particles.

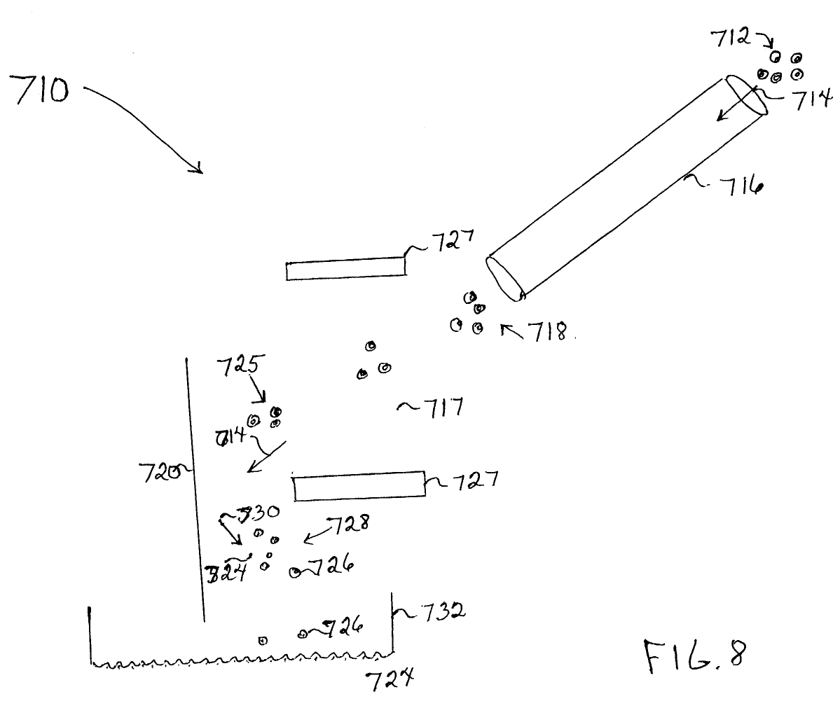

Now referring to FIG. 8 there is shown a another method and apparatus for forming differentially coated particles and their separation. The apparatus is a electric field heater/separator generally indicated by the numeral 710.

The electric field heater/separator 710 operates as follows. A mixture generally indicated by the numeral 712 of two or more coated particle types is accelerated by a flow of air generally indicated by the arrow 714 through a tube 716. Mixture 712 contains one or more particles having a dielectric constant such that they are capable of being heated by to a greater degree by an high frequency electric field than for at least one other particle in the mixture of coated particles. The accelerated mixture of coated particles generally indicated by the numeral 718 is passed through a energy imparting device in the form of an high frequency electric field 717 generated by an electric field generator 727, of a type well known in the art, for thermally stressing [heating] at least one particle type to a greater extent than for at least one other particle type in the mixture for forming a mixture generally indicated by the numeral 725 of differentially thermally stressed coated particles. In the preferred form of the invention, high frequency electric field 717 is between 50 Hz to 100 Ghz for differentially heating differing particle types due to differences in dielectric loss. Field 717 can be either continuously or intermittently applied to the coated particles. Mixture 725 is then exposed to an additional energy imparting device in the form of a contact surface 720 for imparting energy to mixture 725 of differentially thermally stressed coated particles for removing matter form at least one coated particle type 724 to a greater extent than for at least one other particle type 726 for forming a mixture of differentially coated particles generally indicated by the numeral 728. Mixture 728 falls in the direction indicated by the arrow 730 and into a screen shaker 732 for separating particle types 724 and 726 from each other for separating the differing types of particles.

In another form of the invention, the particles are selectively heated by a combination of both high frequency magnetic and electric fields for selectively thermally stressing the coated particles.

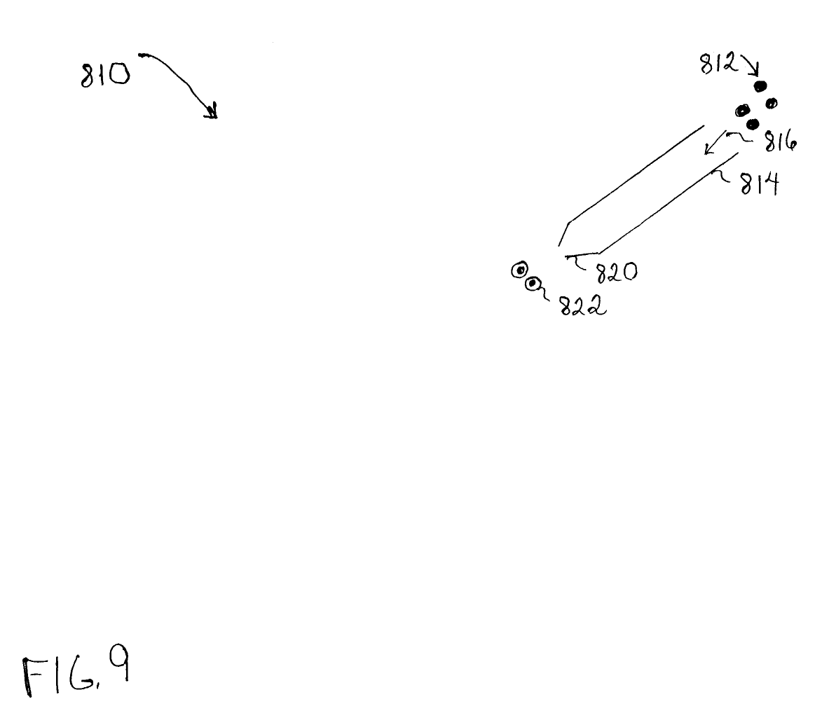

Now referring to FIG. 9, there is shown a method and apparatus for coating particles by condensation. The apparatus is a particle coating apparatus generally indicated by the numeral 810.

The particle coating apparatus 810 operates as follows. A mixture of particles 812 is passed into a tube or channel 814 by a flow of gas generally indicated by the numeral 816. Tube 814 is in thermal contact with a exchanger 818 for lowering the temperature of the mixture of temperature 812 to just above the dew temperature of gas 816. The gas can be comprised of water or water and a gas for forming ice or a gas hydrate. The mixture of gas 816 and particles 812 is then passed through an expansion nozzle 820 for expanding the mixture for forming coated particles 822 by condensation processes. The coated particles can be in the form of ice or gas hydrate covered particles that are at least partially transparent to visible light and selected wwavelenghts of micowaves.

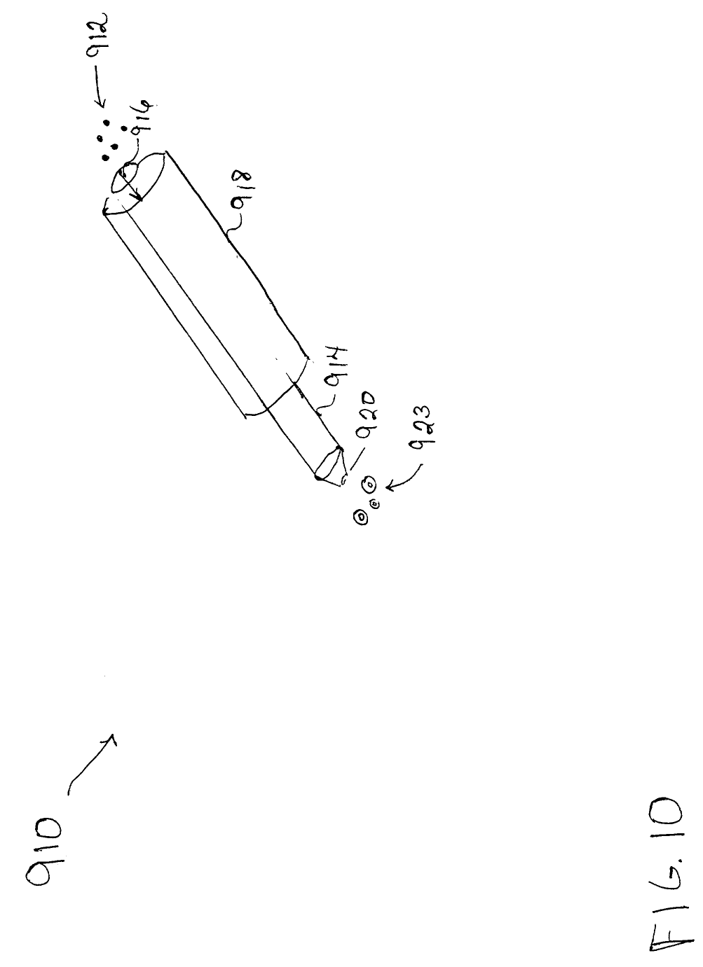

Now referring to FIG. 10, there is shown a method and apparatus for coating a mixture of particles with differing thicknesses. The apparatus is a particle cooling/condensation apparatus generally indicated by the numeral 910.

The particle cooling/condensation apparatus 910 operates as follows. A mixture of particles 912 is passed into a tube 914 by a flow of gas 916. Tube 914 is in thermal contact with a heat exchanger 918 for heating the mixture of particles to a temperature at least 5 degrees C above the dew point of gas 916. The mixture of gas 916 and particles 912 is then passed through an expansion nozzle 920 for condensating a greater amount of gas 916 onto particles having a higher thermal conductivity or lower specific heat than for other particle types having a higher specific heat for forming a mixture of particle types having differing thicknesses.

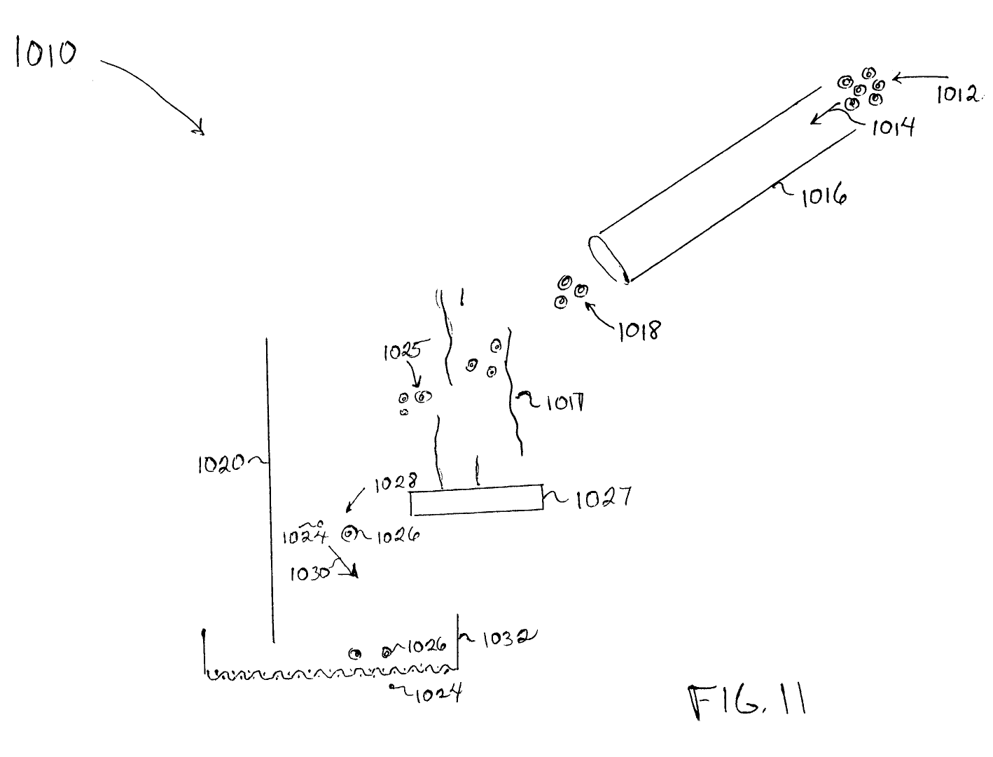

Now referring to FIG. 11 there is shown a another method and apparatus for forming differentially coated particles and their separation. The apparatus is an electromagnetic heater/separator generally indicated by the numeral 1010.

The electromagnetic heater/separator 1010 operates as follows. A mixture generally indicated by the numeral 1012 of two or more coated particle types is accelerated by a flow of air generally indicated by the arrow 1014 through a tube 1016. Mixture 1012 contains one or more particles having differing absorption characteristics such that they are capable of being heated by to a greater degree by an electromagnetic radiation of a selected wavelength(s) than for at least one other particle in the mixture of coated particles. The accelerated mixture of coated particles generally indicated by the numeral 1018 is passed through a energy imparting device in the form of an intense electromagnetic radiation 10110 generated by an electromagnetic radiation generator 1027, of a type well known in the art, for thermally stressing [heating] at least one particle type to a greater extent than for at least one other particle type in the mixture for forming a mixture generally indicated by the numeral 1025 of differentially thermally stressed coated particles. In one form of the invention, the electromagnetic radiation is in the visible range of the spectrum [from 300 to 700 nanometers] for differentially heating different particle types that are colored differently. In this form of the invention, it is preferred that the coating be at least partially transparent to the selected wavelength of light. For this purpose the coating can be made of, for example and limiting the invention to, ice or a gas hydrate. The electromagnetic radiation 1017 can be either continuously or intermittently applied to the coated particles. Mixture 1025 is then exposed to an additional energy imparting device in the form of a contact surface 1020 for imparting energy to mixture 1025 of differentially thermally stressed coated particles for removing matter form at least one coated particle type 1024 to a greater extent than for at least one other particle type 1026 for forming a mixture of differentially coated particles generally indicated by the numeral 1028. Mixture 1028 falls in the direction indicated by the arrow 1030 and into a screen shaker 1032 for separating particle types 1024 and 1026 from each other for separating the differing types of particles.

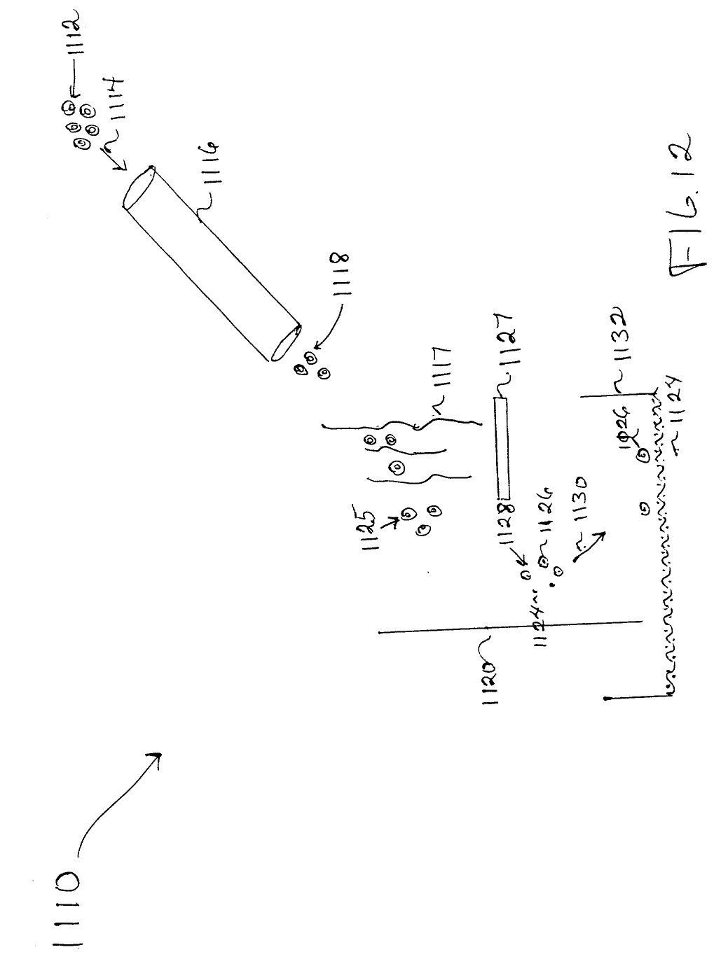

Now referring to FIG. 12, there is shown a another method and apparatus for forming differentially coated particles and their separation. The apparatus is an microwave heater/separator generally indicated by the numeral 1110.

The microwave heater/separator 1110 operates as follows. A mixture generally indicated by the numeral 1112 of two or more coated particle types is accelerated by a flow of air generally indicated by the arrow 1114 through a tube 1116. Mixture 1112 contains two or more particle types having different induction heating characteristics (i.e, distinct thermal, dielectric strength and/or loss tangent characteristics such that at leat one particle type is capable of being heated by to a greater degree by an microwave radiation of a selected wavelengths than for at least one other particle in the mixture of coated particles. The accelerated mixture of coated particles generally indicated by the numeral 1118 is passed through a energy imparting device in the form of an microwave radiation 1110 generated by an microwave generator 1127, of a type well known in the art, for thermally stressing [heating] at least one particle type to a greater extent than for at least one other particle type in the mixture for forming a mixture generally indicated by the numeral 1125 of differentially thermally stressed coated particles. In one form of the invention, the microwave frequency is held at 10 Ghz for passing through a water and/or ice coating. The microwave radiation 1117 can be either continuously or intermittently applied to the coated particles. Mixture 1125 is then exposed to an additional energy imparting device in the form of a contact surface 1120 for imparting energy to mixture 1125 of differentially thermally stressed coated particles for removing matter form at least one coated particle type 1124 to a greater extent than for at least one other particle type 1126 for forming a mixture of differentially coated particles generally indicated by the numeral 1128. Mixture 1128 falls in the direction indicated by the arrow 1130 and into a screen shaker 1032 for separating particle types 1124 and 1126 from each other for separating the differing types of particles.

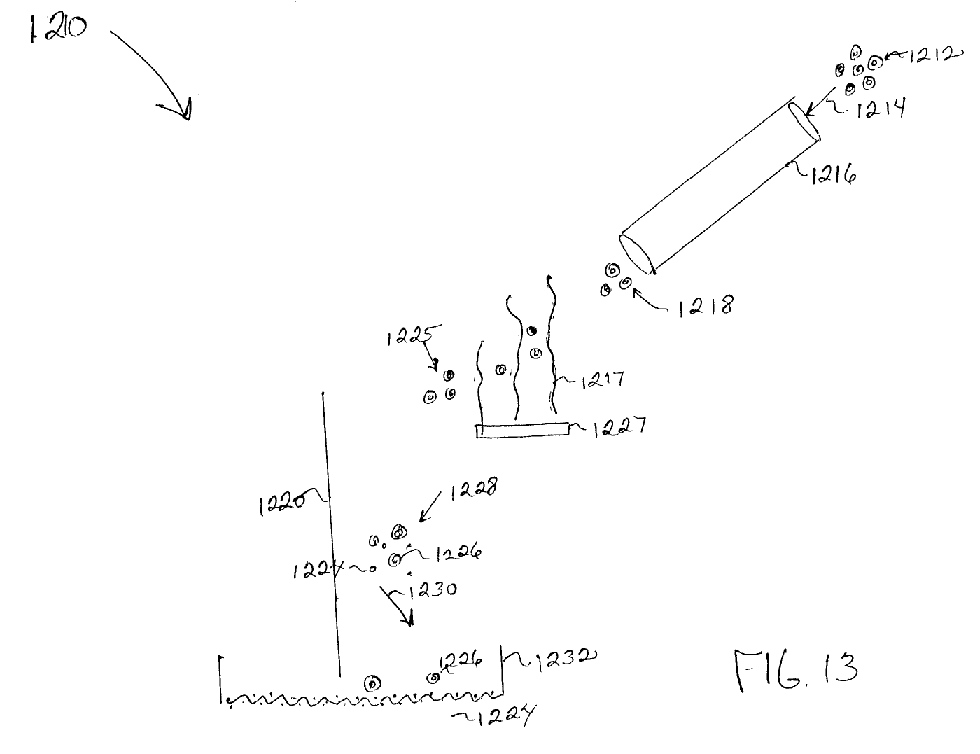

Now referring to FIG. 13 there is shown a another method and apparatus for forming differentially coated particles and their separation. The apparatus is an electromagnetic conduction heater/separator generally indicated by the numeral 1210.

The electromagnetic heater/separator 1210 operates as follows. A mixture generally indicated by the numeral 1212 of two or more coated particle types is accelerated by a flow of air generally indicated by the arrow 1214 through a tube 1216. Mixture 1212 contains one or more particles having differing absorption characteristics and/or thermal conductivities such that they are capable of being heated by to a greater degree by an electromagnetic radiation of a selected wavelength(s) than for at least one other particle in the mixture of coated particles. The accelerated mixture of coated particles generally indicated by the numeral 1218 is passed through a energy imparting device in the form of an non-intense electromagnetic radiation 1210 generated by an electromagnetic radiation generator 1227 for a time sufficient for at least one particles type to transfer heat away from the interface for heating that particle type to a lessor extent than for at least one other type for forming a mixture generally indicated by the numeral 1225 of differentially thermally stressed coated particles. In this form of the invention, it is preferred that the coating be at least partially transparent to the selected wavelength of light. The electromagnetic radiation 1217 can be either continuously or intermittently applied to the coated particles. Mixture 1225 is then exposed to an additional energy imparting device in the form of a contact surface 1220 for imparting energy to mixture 1225 of differentially thermally stressed coated particles for removing matter form at least one coated particle type 1224 to a greater extent than for at least one other particle type 1226 for forming a mixture of differentially coated particles generally indicated by the numeral 1228. Mixture 1228 falls in the direction indicated by the arrow 1230 and into a screen shaker 1232 for separating particle types 1224 and 1226 from each other for separating the differing types of particles.

I claim:

1. A method for the separation of a mixture of differing particulate types, said method comprising the steps of:
a) selecting a coating material;
b) coating said coating material onto at least two different particulate types in said mixture of differing particulate types for forming a mixture of coated particulate types;
c) measuring the fracture strength of at least one coated particulate types in said mixture of coated particulate types under at least one applied stress subjected at a controlled rate;
d) applying at least one substantially uniform stress on at least one coated particulate type in said mixture of coated particulate types at a controlled rate for fracturing at least one coated particulate type in said mixture of coated to a greater degree than for at least one other particulate type in said mixture of coated particulate types for forming a mixture of differentially fractured types;
e) separating said mixture of differentially fractured types for separating said mixture of differing particulate types.

2. A method according to claim 1, including the step of coating said coating material onto at least two different particulate types in said mixture of differing particulate types for forming a mixture of coated particulate types at least one of the coated particulate types in said mixture of coated particulate types having a different fracture strength then at least one other coated particulate type in said mixture of coated particulate types

3. A method according to claim 1, including the step of selecting a coating material for coating said mixture of differing particulate types for forming a mixture of coated particulate types having differing fracture strengths.

4. A method according to claim 1, including the step of applying said stress on said at least one coated particulate type for fracturing at least one coated particulate type in said mixture of coated particulate types to a greater extent than for at least one other particulate type in said mixture of coated particulate types for forming a mixture of fractured particulate types having differing bulk properties.

5. A method according to claim 3 wherein the mixture of fractured particulate types have differing bulk properties from the group consisting of size, shape, heat conductivities, ability to be magnetically manipulated and density.

6. A method according to claim 1, including the step of applying said stress on said at least one coated particulate type for fracturing at least one coated particulate type in said mixture of coated particulate types to a greater extent than for at least one other particulate type in said mixture of coated particulate types for forming a mixture of fractured particulate types having differing surface properties.

7. A method according to claim 3 wherein the mixture of fractured particulate types have differing surface properties from the group consisting of refractive index, luminosity, fluroence, absorbance, catalytic nature, conductivities, ability to become electrostatically charged, hydrophobic nature.

8. A method according to claim 1, including the step of applying heat from at least one heating source to said mixture of coated particulate types for forming a mixture of differentially strained coated particulate types at least one of the coated particulate types in said mixture of differentially strained coated particulate types having a different fracture strength then at least one other coated particulate type in said mixture of differentially strained coated particulate types and applying at least one stress on at least one coated particulate type in said mixture of differentially strained coated particulate types for fracturing at least one coated particulate type in said mixture of differentially strained coated particulate types for forming a mixture of differentially fractured types.

9. A method according to claim 1, including the step of exposing said mixture of coated particulate types to a fluid for changing the fracture stress of said coated particulate types.

10. Uniformly heating said mixture of coated particulate types for changing the fracture strength of at least one coated particulate type for forming a mixture of coated particulate types having differing fracture strengths.

11. A method according to claim 1, including the step of applying a stress on at least one coated particulate type in said mixture of coated particulate types for fracturing at least one coated particulate type in said mixture for forming a mixture of differentially electrostatically charged types and electrostatically separating said differentially electrostatically charged types for separating said mixture of differing particulate types

12. A method according to claim 1, including the step of selecting a mixture of differing particulate types to be separated.

13. A method according to claim 12, wherein selected mixture selected from the group consisting of minerals, coal and catalytic materials.

14. A method for the separation of a mixture of differing particulate types, said method comprising the steps of:
a) differentially coating with a coating material at least two different particulate types in said mixture of particulate types for forming a mixture of differentially coated particulate types;
b) applying at least one stress to at least one particulate type in said mixture of differentially coated particulate types for releasing said at least a portion of coating material from at least one coated particulate type in said mixture of differentially coated particulate types to a greater extent than for at least one other particulate type for forming a mixture of differentially decoated particulate types;
c) separating the differentially decoated particulate types for at least partially separating the differing particulate types.

15. A method according to claim 14, including the step of trapping matter from the group consisting of fluid and particles in between one or more particulate types and a coating material to a greater extent than for at least one other particulate type for forming said differentially coated particulate types.

16. A method according to claim 14, including the step of selectively forming a fluid layer in between at least one of particulate type and a coating material to a greater extent than for at least one other particulate type for forming said differentially coated particulate types.

17. A method according to claim 14, including the step of selectively forming a interfacial composition in between at least one of particulate type and a coating material to a greater extent than for at least one other particulate type for forming said differentially coated particulate types.

18. A method according to claim 14, including the step of selectively forming a cured layer in between at least one of particulate type and a coating material to a greater extent than for at least one other particulate type for forming said differentially coated particulate types.

19. A method according to claim 14, including the steps of selecting a mixture of differing particulate types having differing wetting abilities to a coating material and exposing said particulate types to said coating material for coating at least one particulate type in said mixture of differing particulate types to a greater extent than at least one other particulate type for forming differentially coated particulate types and then coating said differentially coated particulate types with another coating material for forming differentially double coated particulate types and then applying at least one stress to at least one particulate type in said mixture of differentially double coated particulate types for forming a mixture of differentially decoated particulate types.

20. A method according to claim 14, further including the steps of coating said mixture of differing particulate types with a coating material for forming a mixture of coated particulate types and then holding said mixture of coated particulate types at a substantially uniform temperature for forming a fluid layer at the interface of at least one coated particulate type to a greater extent than for at least one other coated particulate type for forming said mixture of differentially coated particulate types.

21. A method according to claim 1, including the steps of selecting said mixture of particulate types to be separated for having differing surface energies for forming a mixture of coated particulate types having differing pressure or abrasion sensitivities.

22. A method according to claim 1, including the steps of selecting said mixture of particulate types to be separated for having differing abilities to form compounds with a material coating and coating said coating said mixture of differing particulate types with said coating material for forming a mixture of coated particulate types having differing fracture strengths.

23. A method for the separation of a mixture of differing particulate types, said method comprising the steps of:
a) selecting a coating material;
b) coating said coating material onto at least two different particulate types in said mixture of differing particulate types for forming a mixture of coated particulate types at least one of said coated particulate types having at least one boundary layer;
c) applying a stress to said mixture of coated particulate types separating matter at a boundary layer for forming a mixture of differentially bounded particulate types;

24. A method according to claim 23, including the step of selecting a coating material for forming coated particulate types having different boundary layers as a result of at least one of the following particulate properties: particulate composition, crystalline structure particulate morphologies, number and/or kind or defect structures present on the surface, ability to become interdiffused or react with the coating material, the differences in the surface free energies of the particulates, particulate mudulii, particulate size and the hydrophobic nature of the surface.

25. A method according to claim 21, including the step of stressing at least one particulate type in at least one boundary layer to a greater extent than for at least one other particulate type for forming said mixture of differentially bounded particulate types.

26. A method according to claim 21, including the step of stressing at least one particulate type in the region of interface or interphase of the boundary layer for forming said mixture of differentially bounded particulate types.
